(19) United States
(12) Patent Application Publication
(10) Pub. No.: US 2024/0263449 A1
(43) Pub. Date: Aug. 8, 2024

(54) STRUCTURAL BEAM FORMED FROM LUMBER

(71) Applicant: Andrew T. K. DEWBERRY, Vancouver (CA)

(72) Inventor: Andrew T. K. DEWBERRY, Vancouver (CA)

(21) Appl. No.: 18/568,739

(22) PCT Filed: Mar. 30, 2022
(86) PCT No.: PCT/CA2022/050478

§ 371 Date: Dec. 8, 2023

(30) Foreign Application Priority Data
Jun. 9, 2021 (CA) 3121756

(51) Int. Cl. E04C 3/16

(52) U.S. Cl. CPC E04C 3/16

(57) ABSTRACT

A castellated wood beam, comprises a first beam section and a second beam section, said first beam section and said second beam section being cut from an initial wood blank along a cut line pattern defining a plurality of section lands and section grooves in the first beam section and the second beam section. The first beam section lands are connected with the second beam section lands after rotating one of the first beam section and the second beam section with respect to the other beam section about a rotation axis transverse to a longitudinal axis of the initial wood containing blank and aligning the lands.

### FIELD OF THE INVENTION

This invention relates to a structural beam and its method of construction using wood.

### BACKGROUND OF THE INVENTION

Castellated beams are well known in the art as a form of beam readily created from a smaller section beam in order to generate improved structural capacity and a fenestrated section. The benefits are created without additional weight of material and with minimal complexity in manufacturing. Castellated beams are generally manufactured by cutting a conventional I-beam into two beam sections, separating the subsections and then re-joining the two beam subsections into a castellated beam. The techniques and technology are all standard practice in the field of metalworking. Typically, castellated beams are used to substitute for solid or latticed horizontal or canted beams in the construction of spanning elements in building works. Instances of the efficient use of lattice beams outside the metalworking industry are not readily found as experience guides that outside of the field of metalworking the historical techniques involved fail to economically generate an efficient structural form.

As is illustrated FIGS. 1(a) and (b), the traditional castellated beam production process seeks to effectively deepen the cross-section of an existing beam of the same outward form through simple manipulative actions that transmute the original member. In the illustration, the most typical example is shown which is the refabrication of an I beam 2 from one lesser cross-sectioned beam into a similar beam 4 of larger cross-section. By doing so, the fabricator gains considerable resistance to bending stresses by virtue of the enhanced depth of section 6 at no increase in weight per length of beam of the structural element. On the other hand, there is a cost of additional skilled or machine work in fabrication and a small loss of overall length of the beam. These beneficial and deleterious factors are inherent to the forming of such beams and must be balanced to achieve cost effective production of the resultant structural element.

The systematic reformation of a previously complete beam into one exhibiting the desired improvements is known to be completed in three stages as shown in FIGS. 2(a) to 2(d). First, the operator cuts the original beam 2 in a desired pattern 5 within the central or web portion as shown in FIG. 2(a). Secondly, the operator separates the cut portions 7, 7′ and moves them horizontally with respect to each other until the protruding portions 8 align (FIGS. 2(b) and 2(c)). Excess misaligned protruding ends 6 are also removed from cut portions 7,7′ as shown in FIG. 2(c). Thirdly, the operator re-connect the two parts to create a new, deeper unit 4 with web apertures 9 as shown in FIG. 2(d).

Although this procedure is well known, it is sparsely used even in steel fabrication using well tried methods and materials. The known cost factors typically make the alterations of questionable economic value and there are significant negative affects following completion of the castellation procedure for the beam to find ready use in industry. The deleterious characteristic changes to the beam correlate to the much desired increase in web dimensions exacerbated by the discontinuity introduced into the centre-line of the web itself. New potential modes of failure demand close attention to symmetry of the section in fabrication, installation and loading. Errors of symmetry or continuity of reattachment of the cut portions 7, 7′ generate significant challenges to the calculation of actual load carrying ability. There is increased potential for failure of a castellated beam in comparison to a standard beam produced with similar overall dimensions without the castellation processes. For materials other than metal that do not exhibit the material uniformity and consistency that is a feature of industrially produced metal, these problems of symmetry and continuity of attachment can be even more pronounced.

Others have developed castellated elements made of diverse materials other than metal. Most notably, US Patent Application Publication number 2005/0086898 (Robak) describes the process for making castellated wood members from post-production dimensional lumber. Robak employs the standard method of castellation from the art of metal fabrication to cut a solid wood member 10 with a castellation line 11 as shown in FIG. 3(a) and reform it into a castellated member 12 of deeper cross-sectional area with voids 14 as shown in FIG. 3(b).

The dimensional lumber castellation process of Robak simply mimics steel fabrication techniques. Compared with the benefits of metal fabrication, there are a number of basic economically and structurally necessary outcomes that fail to be met when the procedure uses materials other than steel. The deficiencies between the outcome of the procedure in non-metal elements are due entirely to the nature of the material involved. That there is a qualitatively different outcome in the product produced by the Robak method in view of the different material being used is not explored or discussed in Robak.

### SUMMARY OF THE INVENTION

Unlike prior attempts to make castellated beams from wood, the embodiments described below take into account the nature of the material involved. Contrary to prior designs, the described embodiments of the present application do not seek simply to migrate a beam construction technique from the metalworking field to the wood processing field. Rather, the described embodiments of the present application have been developed with an appreciation of the characteristic differences between the different materials used. In this case, the production of castellated products from metal, mainly steel, cannot be followed when considering a non-uniform material such as wood which must go through multiple processes to become efficiently utilisable.

Accordingly, there is described a castellated beam member derived from sawn logs for use in construction as dimensional lumber.

In one embodiment, there is provided a castellated wood beam, comprising:
a first beam section and a second beam section cut from an initial wood blank along a cut line pattern defining a plurality of section lands and section grooves in the first beam section and the second beam section; and
the first beam section lands being connected with the second beam section lands after rotating one of the first beam section and the second beam section with respect to the other beam section about a rotation axis transverse to a longitudinal axis of the initial wood containing blank.

In another aspect, there is described a method of forming a castellated wood beam, comprising:
cutting a wood blank having a longitudinal axis along a cut line pattern to divide the wood blank into a first beam section and a second beam section, the cut line pattern defining a plurality of first beam section lands, first beam section grooves, second beam section lands and second beam section grooves;
rotating one of the first beam section and the second beam section with respect to the other beam section about a rotation axis transverse to the longitudinal axis;
aligning the first beam section lands with the second beam section lands; and
connecting the first beam section lands with the second beam section lands to form a castellated beam.

### BRIEF DESCRIPTION OF THE DRAWINGS

Aspects of the present invention are illustrated, merely by way of example, in the accompanying drawings in which:

FIGS. 1(a) and (b) show a prior art steel I-beam that is cut and assembled into a conventional castellated I beam;

FIGS. 2(a) to (d) show the prior art castellation process in more detail;

FIGS. 3(a) and (b) show a prior art castellation process according to Robak applied to dimensional lumber;

FIGS. 4(a) to (f) show wet and dry cut cross-sections of a wood source log, and the conversion of a dry cut wood piece into a finished lumber piece;

FIGS. 5(a) to (e) illustrate the manufacturing steps according to a preferred embodiment of the present process;

FIGS. 6(a) and (b) illustrate non-uniform growth in an original log; and

FIGS. 7(a) to (e) illustrate forms of warp in lumber;

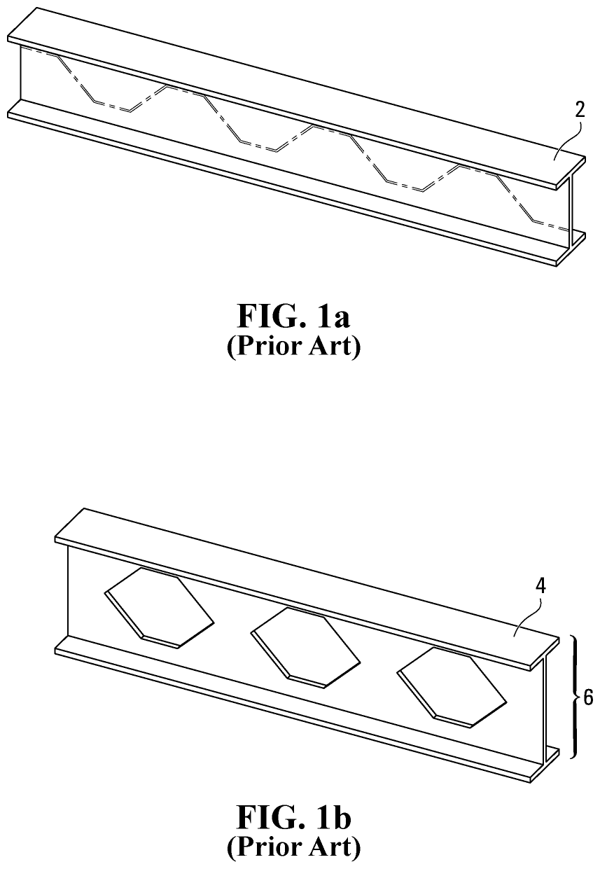

### DESCRIPTION OF THE PREFERRED EMBODIMENTS

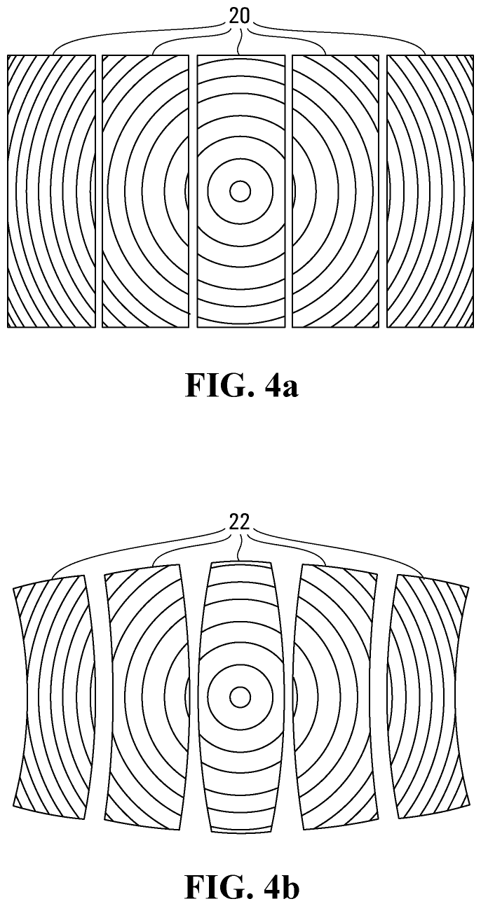

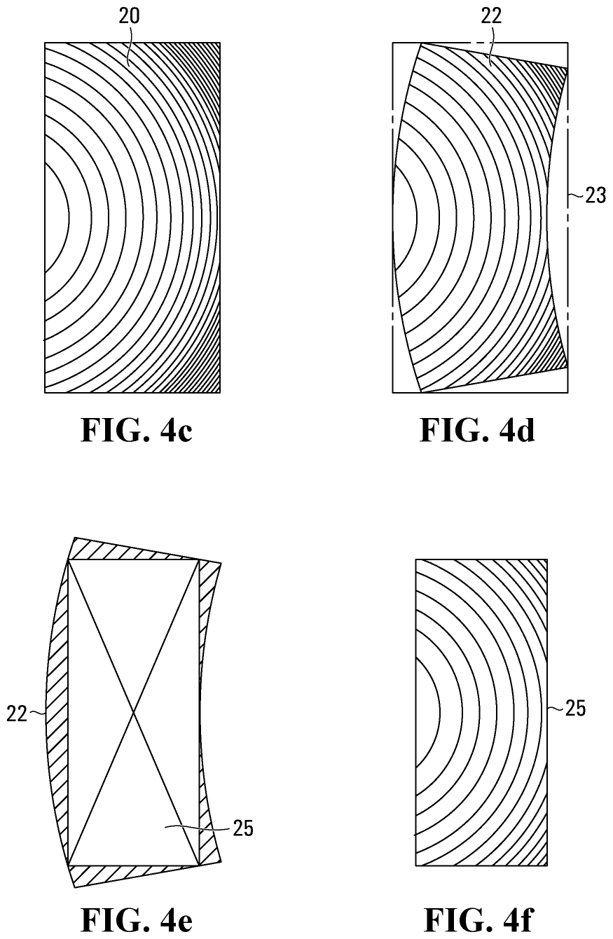

Dimensional lumber is a major industrial product with well defined economic and physical constraints. As best shown in FIG. 4(a), lumber pieces 20 are cut from a log of roughly circular cross-section. Economic production practices seek to maximise the amount of dimensional lumber that can be sawn from any given cross section. This is careful controlled by highly developed software programs working in conjunction with highly accurate detection systems that define the physical characteristics of each log and portions thereof in a continuous production line. However, despite the electronic evaluation and selection, precision of cutting, and uniformity of moisture content reduction, each cut lumber piece exhibits irremediable material inconsistencies due to the natural growth from which it is sourced. The inconsistencies are well known in the art and include normal growth patterns, growth faults such as shakes, twists, knots and varying moisture content. These differences are inherent in the raw log material and are exposed in the cutting process. These natural inconsistencies cause the major part of the inconstancy of any given cut lumber piece, and they tend to be exacerbated through the drying process. When moisture content is lost from wood in its natural ‘green’ state, as is required for it to be used as a structural construction element, differential movement will occur. Movement will be in all planes and any given board may exhibit characteristics after drying of single or multiple deformation phenomena. FIG. 4(b) shows the expected outcomes for dried lumber pieces 22 cut from various locations on the cross-section of any given log and examples of simple characteristic longitudinal warping.

Traditional lumber mill practice sees the log sawn to oversize lumber pieces 20 as shown in FIG. 4(c), then kiln dried into dried lumber piece 22 as shown in FIG. 4(d). Due to the drying process, the dried lumber piece 22 will have moisture loss movement and will diverge from rectilinear as represent by dashed box 23 in FIG. 4(d). Dried lumber pieces 22 are then planed to good on all four sides as shown in FIG. 4(e). The process is highly efficient utilising factory production methods and very large or continuous production runs. At the completion of the process, the existing characteristic flaws exhibited by any cut lumber pieces 22 have been allowed for and compensation made in order to achieve a standard dried lumber piece 25 (FIG. 4(f)) having nominal dimensions and exhibiting structural qualities that aggregate to an acceptable and calculable structural capacity that is the purpose of dimensional lumber. As shown particularly in FIG. 4(e), this necessary drive for consistency removes substantial quantities of good wood that has been allowed to deform in order to produce a common standard.

Unlike prior attempts to make castellated beams from wood, the embodiments described below take into account the nature of the material involved. Contrary to prior designs, the described embodiments of the present application do not seek to merely migrate a technological improvement from one field to another without appreciation of the characteristic difference between those fields. In this instance, the methods of production of castellated products in metal, mainly steel, cannot be followed when considering non-uniform wood materials which go through multiple processes to become efficiently utilisable.

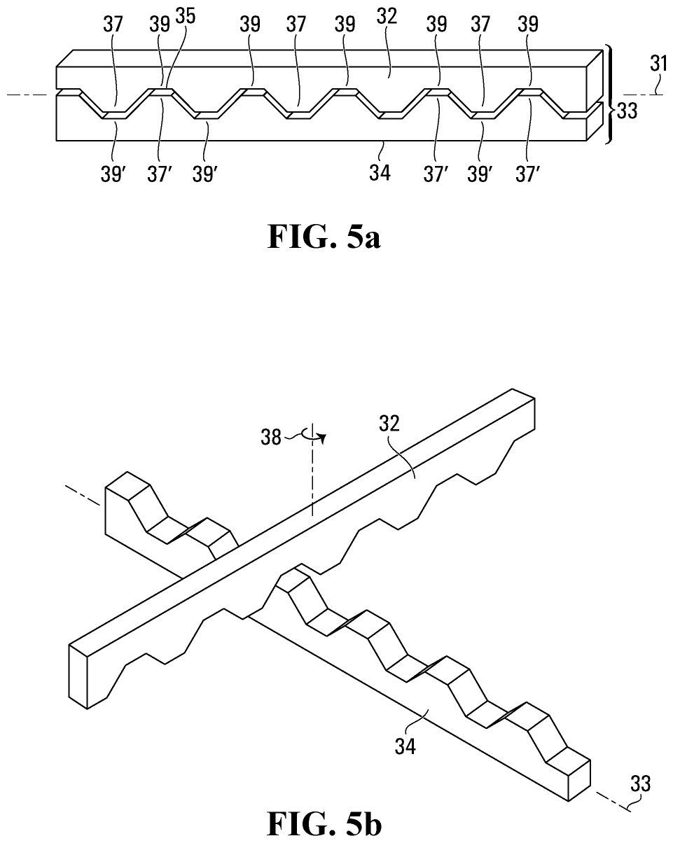

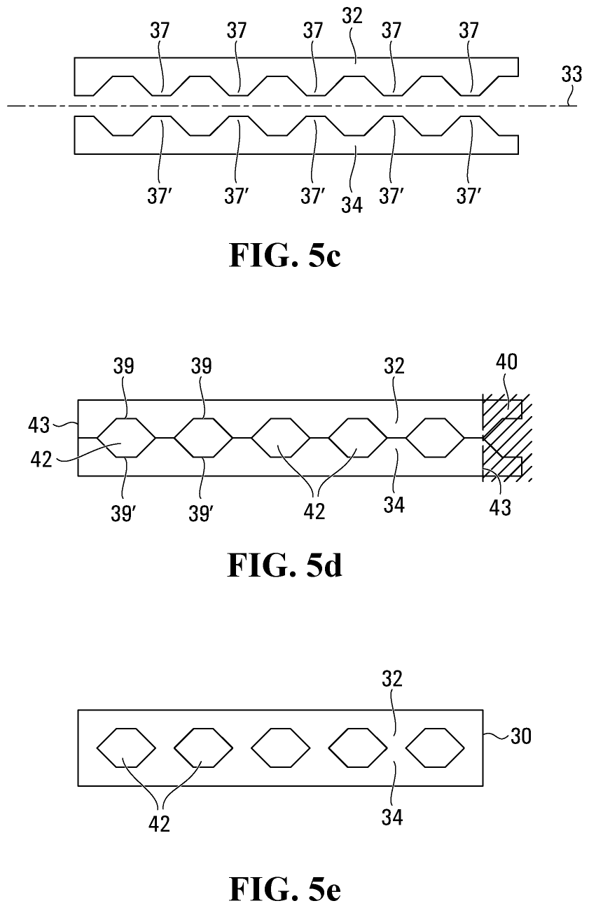

Accordingly, a preferred embodiment of the castellated beam and its method of formation are shown in FIGS. 5(a) to 5(e).

FIGS. 5(a) to (d) show the method of forming a wood blank 31 (FIG. 5(a)) into a completed castellated wood beam 30 (FIG. 5(e)) according to a preferred process.

Initially, wood blank 31 having a longitudinal axis 33 is cut along a cut line pattern 35 to divide the wood blank into a first beam section 32 and a second beam section 34. Wood blank 31 is preferably in a green state with natural moisture content levels and may be newly sawn from a source log.

Cut line pattern 35 defines a plurality of first beam section lands 37, first beam section grooves 39, second beam section lands 37′ and second beam section grooves 39′ as best shown in FIG. 5(a).

After cutting, one of the first beam section 32 and the second beam section 34 is rotated with respect to the other beam section about a rotation axis 38 transverse to the longitudinal axis 33 as shown in FIG. 5(b). Specifically, in FIG. 5(b), upper first beam section 32 is shown being rotated relative to lower second beam section 34.

FIG. 5(c) shows the upper first beam section 32 and the lower second beam section 34 after rotation of upper beam section 32 by 180 degrees and aligning of the first beam section lands 37 with the second beam section lands 37′.

Each pair of aligned section lands 37,37′ are then connected as shown in FIG. 5(d). The plurality of aligned section grooves 39,39′ in the first and second beam sections define openings 42 through the assembled wood beam. In the illustrated embodiment, openings 42 comprise regular hexagons. The openings may comprise other forms such as circles, ellipses or other polygons or combinations thereof depending on the shape of the cut line pattern 35.

At this stage, one or both ends of the newly formed castellated beam 30 may be trimmed at 40 to create planar ends 43 to the formed beam.

FIG. 5(e) shows the assembled castellated wood beam 30 comprising a first beam section 32 and a second beam section cut from an initial wood blank 31 with openings 42 therethrough.

The assembled beam 30 may then be dried in a kiln and planed in additional processing steps to arrive at a finished product.

In the illustrated embodiment of FIGS. 5(a) to (e), each of the plurality of section lands 37, 37′ are preferably flat to define planar, abuttable surfaces between the lands of the first beam section and the lands of the second beam section to maximize the contact area between the connected section lands.

In the connecting step of assembling castellated wood beam 30, the plurality of section lands may be connected by an adhesive, by mechanical fasteners or a combination of both.

The preferred adhesive is a moisture curing polyurethan adhesive which uses water to initiate the curing process. The adhesive is spread in sufficient density directly onto the wood faces of the lands. The assembled composite may be pressed and held at a defined pressure for a predetermined period appropriate to the adhesive used. For example, the assembled composite may be pressed at a relatively low pressure of 1 MPa. Once sufficient strength of the adhesive bond is established for transfer, the beam may be moved to a kiln for drying where the drying process adds strength to the glue. The pressing period may be a few hours or less depending on the adhesive.

While gluing is the preferred connection arrangement, it is also possible to include mechanical fasteners. For example, automated screw fastening from opposite side faces of the beam across the land surfaces may be used to supplement the gluing. Alternatively, a multitude of shot fired small cross-sectional pins from each side of the beam across the land surface may be used. Preferably, the pins would deform against the grain of the wood such that the resulting twist or curve distortion would add to the holding resistance of the fastener.

In any mechanical fastener system, it is important to ensure that there is no fastener portion protruding beyond the plane of any outer face of the castellated beam. This especially so if the assembled beam is to undergo any planing after drying. Preferably, any mechanical fasteners are introduced to remain at least a few mm below the surface in all cases.

As set out above, embodiments of the castellated beam are preferably formed using newly sawn wood in a green state with natural moisture content levels. Modern material cutting techniques in the form of a water jet are preferably used to cut the wood blank into two shaped section 32 and 34. The methodology of creating the cut lines following a defined path uses non-traditional industrial scale machining processes for wood.

The traditional methods of wood forming and reduction in modern industrial plants include blades of various scale and form such as circular saw blades, reciprocating saw blades and band saw blades. Of these, the band saw and reciprocating saw are capable of following the cutting path to create the requisite flowing form of corners in a wood blank. However, the nature of the cutting blade is such that in any corner cutting manoeuvre there will be jagged imperfections visible where the blade teeth have been forcibly turned against its natural tendency to continue straight or follow the grain of the wood. This introduces a weakening imperfection. It is known in the art of materials in general that jagged imperfections act to focus imposed forces inwardly concentrating stress at the inner radius and so rapidly instigating a line of structural failure. The nature of the wood as a material is such that the blade and teeth cannot approach a scale at which this manufacturing error is not considerable. To penetrate and maintain a cut through green wood of thickness greater than a knife cuttable veneer, especially when manoeuvring around corners, demands a relatively substantial blade depth and width to prevent failure due to overheating, and stretching. In addition, to prevent fouling of the teeth of the blade by the build-up of water soaked debris of the cutting process in green wood, the industry has developed large toothed blades with a maximal distance between the teeth. Therefore, the nature of the wood material and the sawing solutions developed to mitigate against the characteristics of the wood material mean that traditional wood sawing methods will not work well in producing the necessary cut line in the wood member as a precursor to castellation of the member.

Alternatively, a wood member may also be cut using routing techniques in which a spindle rotating at high speed is directed through the wood along the required line. This methodology may readily be used to create the desired cut line. However, in order to reduce failure due to processes directly analogous to those noted previously for saw blades, the router bit needs to be deeply toothed and of considerable girth to ensure that the length of penetrating cut can be maintained without fouling of the bit by wet off-cut detritus or deformation and failure due to lateral forces imposed during routing. As a result, the cut line width must be of a relatively significant size compared to a given depth of wood. As a result, using a large router bit cancels much of the desired advantage of the castellation process which relies on original material reduction through the use of smaller sections to generate larger structurally competent sections.

For efficient usage of wood as a base material, the castellation cut needs to be undertaken using a methodology that can produce a narrow width of waste material during the operation and corner tightly and smoothly without fouling. Current technology demonstrates that water jet cutting is available to do such work though the technique is not generally used in wood cutting. This is because the introduction of a wetting agent to kiln dried or naturally dried wood is clearly not an optimal solution given that the wood would then need to be further dried. More drying might introduce further differential movement within the body of the element due to differing densities of cell distribution, differently damaged cells, in addition to original growth imperfections creating circumstances from which further uncontrollable morphological change might occur to the finished product. Once re-dried, the new wood product might once more require trimming to true by planing thereby introducing extra processes and a potential further wastage of wood in the manufacture of the desired product.

Using water jet cutting on wood in its natural or ‘green’ state does not raise these same concerns. Opening up of the wood and enforced drying has not occurred. The introduction of additional water to inner uncut faces might ensure an even distribution of wet wood through the body of the piece. Achieving a known and uniform surface moisture content of substrate promotes consistent adhesive bonding between the faces of the two halves of the cut board and again generates a beneficial improvement in the process.

This is a distinct alteration from the process of producing a castellated element in steel. The cutting of wood in the process of producing the castellated wood structure of the present application cannot be along the lines used for steel castellated beam production wherein fully finished elements are cut and reformed to create an element of larger structural capacity using an efficient minimum of operations. In the case of steel, a torch to both cut and weld suffice.

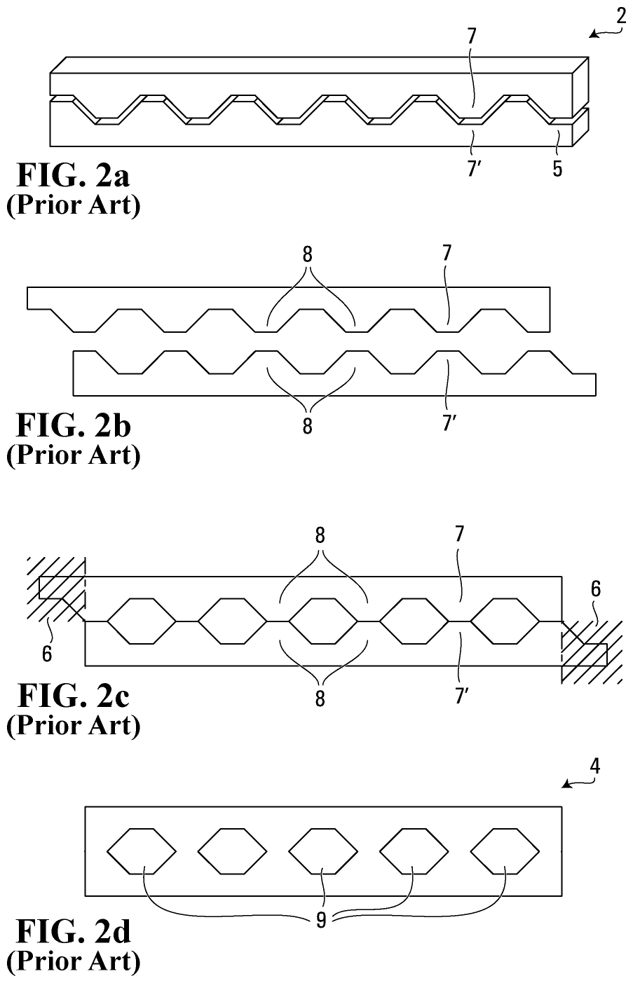

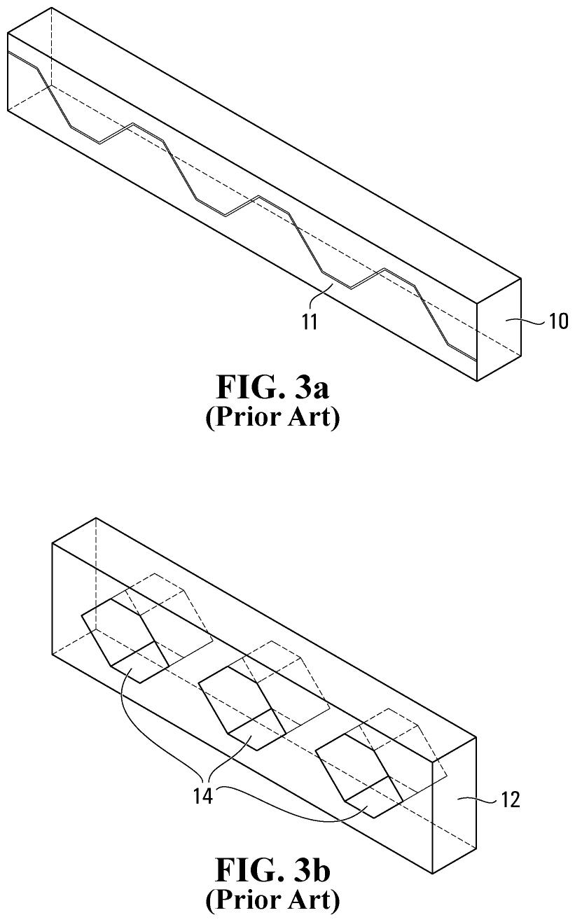

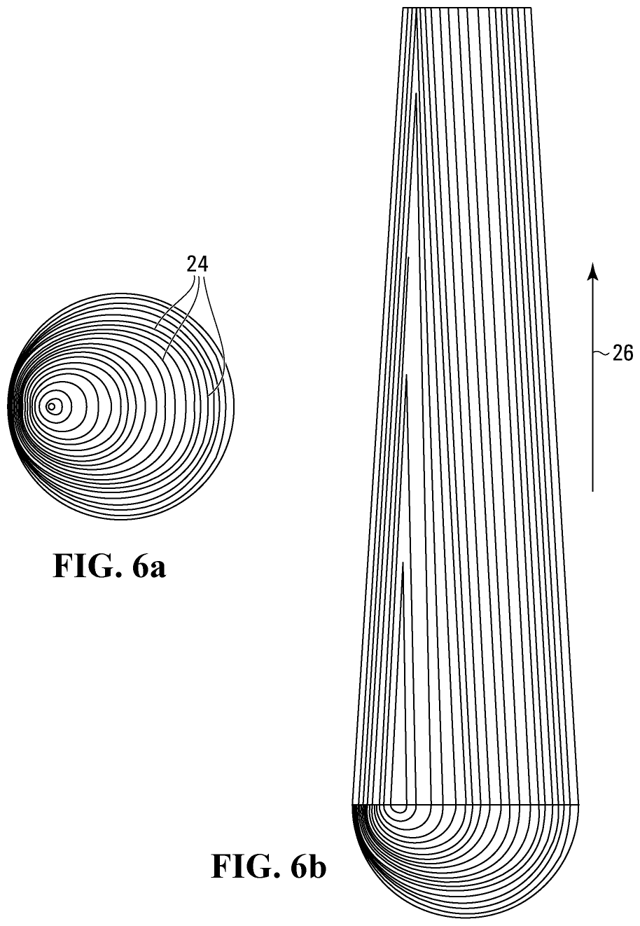

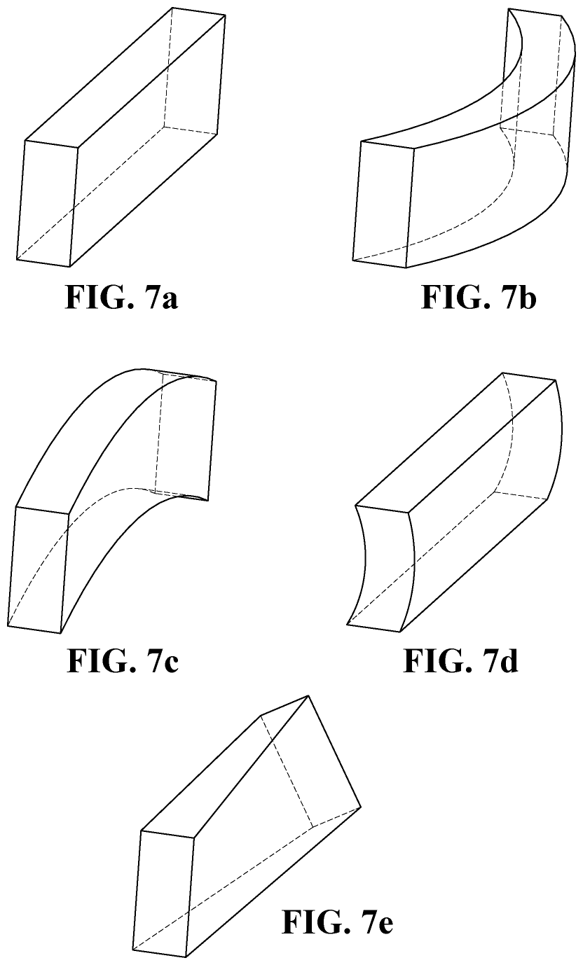

After cutting, the conventional next stage of manufacture of a castellated beam in steel is to simply move the two sides formed from the master blank apart and shift them longitudinally relative to each other in order to line up the peaks ready for re-adhering. This is also directly instructed in the prior art Robak reference and as illustrated in FIGS. 2a to 2d of the present application showing prior art techniques. If this process is followed for wood products, the nature of the wood material will compromise the final fabricated beam to the extent that the structural non-conformity of the material is exacerbated and the desired structural capacity is not achieved. This results from the known non-uniform nature of the base wood material due to its grain. In practice, the wood blank when cut from the original log will feature differing densities and growth patterns within the cross-section. These may be seen as concentric circular rings radiating from a central locus in the instance of a perfectly upright natural growth. They may alternatively be seen to be concentric, non-circular rings 24 of decidedly non-uniform growth i.e. growth was naturally not perfectly upright and the tree may have been affected by loading due to wind, terrain, other plant life, or disease etc. as shown in FIG. 6(a) which is an end view of a typical lumber piece. Likewise, wood will also feature different densities and growth patterns longitudinally. Along the length of any newly cut wood, there is at the very minimum a gentle and symmetrical narrowing of the grain in the original direction of growth as shown by arrow 26 in FIG. 6(b). At worst, these lines of growth are neither symmetrical nor gentle in the density gradient they exhibit. If left unchecked, sawn timber will, upon drying to usable moisture content, exhibit a number of forms of warp along its length. FIGS. 7(a) to 7(e) illustrate various states for sawn timber after drying:

FIG. 7(a) shows an unwarped piece;

FIG. 7(b) shows a bowed piece;

FIG. 7(c) shows a crooked piece;

FIG. 7(d) shows a cupped piece; and

FIG. 7(e) shows a twisted piece.

Various combinations of these wood warping states are also possible in a single piece of sawn timber.

When using wood, if the two cut sides are simply moved apart and displaced laterally relative to each other, the differing densities and therefore structural capacities of the wood at cellular level are realigned along the same face plane, but distally more remote. The resultant structural element will exhibit greater cross-sectional differentiation of response to loading between the two major longitudinal faces compared with uncut beams and any further moisture related movement will be significantly enhanced in its effect. Longitudinally, any propensity to continue to warp generated through long term drying processes is likewise exacerbated. In other words, cutting wood lumber into two parts and then sliding the parts relative to each other enlarges the known indeterminate difference in the two major longitudinal faces structural capacity and adds further formal asymmetry along the main longitudinal axis. To directly follow steps pertinent to steel fabrication, therefore, adds a significant, increased, but indeterminate, structural and formal asymmetry in wood products.

To reduce this defect in wood products, castellated elements may be fabricated with additional strengthening plates across the cut line. These mechanically installed plates add stability and connectivity to the end product to overcome the difficulty associated with replicating the homogenous conformity of uncut units. Multiple part built-up beams may find an occasional structural application, but in practice they are less than optimal as they require additional fabrication steps, and, as a consequence of the numerous parts and fastenings, begin to approach weight equivalence to beams without the benefit of web openings. As a consequence, such fabrications have not found economic favour in the construction industry.

In view of the above discussion, it will be appreciated that simply separating and laterally shifting the cut portions is insufficient for making a castellated wood beam product. To overcome the drawbacks of wood as a material, Applicant has developed the additional step of rotating one of the cut beam portions relative to the other by 180 degrees on the plane of the proposed joint (refer to FIG. 5(b)). Only then should the lands of each beam portion be aligned and adhered together (see FIGS. 5(c) and (d)). The effect of such a rotation is to misalign the natural grain of the wood of the originating wood blank. By this simple, but crucial additional step, the overall average structural capacity of the castellated wood beam 30 in aggregate is improved compared to the use of a solid unit of equal overall dimension despite the fenestrated web and glued connections. By virtue of the rotation step, the newly created wood beam 30 is less asymmetric in cross-section and longitudinal section than a solid beam in similar sections. The solid beam features differential densities of wood at cellular level on both outermost sides of the major longitudinal plane. The castellated beam features equalised densities overall on a cellular level on each outermost face of the major longitudinal plane. On the longitudinal axis, the solid beam features a reducing dimension between growth rings in the direction of growth and the castellated beam brings the two most distal ends together to neutralise the differential.

In traditional dimensional lumber manufacturing, differential shrinkage movement is allowed for and processes introduced to mitigate unavoidable alterations in the rectilinear external faces demanded for dimensional lumber. In practice, this means that each rough sawn board is oversized proportionate to the moisture related movement expected for the type of wood in use. After the drying process is concluded, at which point no further movement due to water loss is expected and the moisture level is below 30%, each board is reduced to the desired size and in so doing any moisture loss produced movement of the original board removed. This process by its nature must assume a reduction of sufficient magnitude to render a board featuring a near maximum movement to be within acceptable tolerances after the finishing process. All boards undergo the same treatment whether movement occurs or not as once cut to allow for movement the individual boards have excessive size which must be reduced to industry stipulated sizing.

In the product and process of the present application, the likely drying induced movement of the wood, once the parts are rotated about each other and bound by a strong glue joint, will tend to counteract each other across the fixed glue boundary and thereby reduce the overall deformation. Reduced deformation directly results in a corresponding reduction in the removal of wood necessary to regain rectilinearity of the overall unit to the dimensions required. On the longitudinal section, the tendencies of the two halves to deflect, through drying, in one or more of the forms possible (see FIGS. 7(a) to (e)) will, when held against each other by a strong glue joint, along the full length of the unit, similarly act against the exact opposite tendency to warp in the other half of the manufactured whole.

The joining of the two halves of the fabricated beam at the central plane acting to prevent the scale of movement that would have occurred if those edges where left to deflect freely also introduces stresses that both reduce the shrinkage affects and pre-loads (locks) the beam in at its central zone to resist further movement. Consequently, the method of the present application adds structural capacity to the final product whereas the prior art for castellated beam manufacture in wood reduces the structural rigidity of the final beam.

Although the present invention has been described in some detail by way of example for purposes of clarity and understanding, it will be apparent that certain changes and modifications may be practised within the scope of the appended claims.

1. A castellated wood beam, comprising:
a first beam section and a second beam section cut from an initial wood blank along a cut line pattern defining a plurality of section lands and section grooves in the first beam section and the second beam section; and
the first beam section lands being connected with the second beam section lands after rotating one of the first beam section and the second beam section with respect to the other beam section about a rotation axis transverse to a longitudinal axis of the initial wood containing blank and aligning the lands.

2. The castellated wood beam of claim 1 in which the plurality of aligned section grooves in the first beam section and the second beam section to define openings through the wood beam.

3. The castellated wood beam of claim 2 in which the openings comprise at least one of a circle, an ellipse and a polygon.

4. The castellated wood beam of claim 1 in which the plurality of section lands are flat to define planar, abuttable surfaces between the lands of the first beam section and the lands of the second beam section to maximize the contact area between the connected section lands.

5. The castellated wood beam of claim 1 in which the plurality of section lands are connected by an adhesive.

6. The castellated wood beam of claim 1 in which the plurality of section lands are connected by mechanical fasteners.

7. The castellated wood beam of claim 1 in which the plurality of section lands are connected by both an adhesive and mechanical fasteners.

8. The castellated wood beam of claim 1 in which the wood beam is formed using a wooden blank in a green state with natural moisture content levels.

9. The castellated wood beam of claim 8 in which the wood beam is dried after being formed.

10. A method of forming a castellated wood beam, comprising:
cutting a wood blank having a longitudinal axis along a cut line pattern to divide the wood blank into a first beam section and a second beam section, the cut line pattern defining a plurality of first beam section lands, first beam section grooves, second beam section lands and second beam section grooves;
rotating one of the first beam section and the second beam section with respect to the other beam section about a rotation axis transverse to the longitudinal axis;
aligning the first beam section lands with the second beam section lands; and
connecting the first beam section lands with the second beam section lands to form an assembled castellated beam.

11. The method of claim 10 in which the cutting step is performed using a water jet.

12. The method of claim 10 in which the wood blank is in a green state with natural moisture content levels when cut.

13. The method of claim 12 in which the wood blank is newly sawn from a source log.

14. The method of any ene of claim 10 in which connecting the first beam section lands with the second beam section lands comprises applying an adhesive and pressing and holding the lands together for a predetermined period.

15. The method of claim 10 in which connecting the first beam section lands with the second beam section lands comprising using mechanical fasteners.

16. The method of claim 10 in which connecting the first beam section lands with the second beam section lands comprising using both an adhesive and mechanical fasteners.

17. The method of claim 10 in which the assembled castellated wood beam is dried.

18. The method of claim 17 in which the dried, assembled castellated wood beam is planed.
